(19) United States
(12) Patent Application Publication
(10) Pub. No.: US 2010/0315673 A1
(43) Pub. Date: Dec. 16, 2010

(54) INFORMATION PROCESSING APPARATUS AND INFORMATION PROCESSING METHOD

(75) Inventor: Takeshi Matsushita, Fujisawa-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/785,411

(22) Filed: May 21, 2010

(30) Foreign Application Priority Data
Jun. 15, 2009 (JP) 2009-142708

(51) Int. Cl. G06F 15/00

(52) U.S. Cl. 358/1.15

(57) ABSTRACT

A file containing multiple image data pieces and a header describing an intended use of the image data pieces is stored, and an instruction to perform processing with use of an image data piece from among the image data pieces is received. Based on the instructed processing and the intended use described in the header, an image data piece from among the image data pieces is determined to be the target of the processing, and then the image data piece determined to be the target of the processing is processed.

### BACKGROUND OF THE INVENTION

1. Field of the Invention

The present invention relates to an information processing apparatus and an information processing method for processing a file containing multiple pieces of image data.

2. Description of the Related Art

Conventionally, in the case of printing data stored in a file, there is a method in which a piece of application software is started up, the file is loaded into the application software, and printing is performed. Also, there is a method of enabling a file to be printed by dragging and dropping the file onto a printer icon on a desktop. Japanese Patent Laid-open No. 2001-337765 discloses a printing control operation system in which, in printing by drag-and-drop, in the case of performing printing after changing a print processing setting, desired print processing can be performed without opening the file to be printed in a piece of application software. Also, with the Linux OS and the like, the file to be printed can be directly designated and printed from the command line with use of the lpr command or the like. In this way, there are conventional methods of performing printing without the intervention of application software.

Focusing now on the configuration of the file itself that is to be printed, Japanese Patent Laid-open No. 2008-167067 discloses an image recording method that enables easily referencing related information of multiple pieces of image data. Japanese Patent Laid-open No. 11-266420 discloses an image recording method in which recorded compressed image data that has been generated in one instance of a recording operation is combined with an independent image data piece. This results in an image file that is a single file storing multiple pieces of image data. In the case of image editing, a target file is dragged and dropped into an editing screen or designated in a file loading menu in a piece of application software, and thus image data in the target file is loaded into the application software, and editing can be performed. Such technology is generally widely-known.

Now consider the case in which a single file containing multiple pieces of image data, such as is disclosed in Japanese Patent Laid-open Nos. 2008-167067 and 11-266420, is printed by a drag-and-drop operation as disclosed in Japanese Patent Laid-open No. 2001-337765. In this case, if all the image data pieces contained in the target file are printed, images not needed by a user will end up being printed. In contrast, consider the case in which the user is always caused to select images to be printed before printing is performed. In this case, even if, for example, an image data piece that is a main image and a second image data piece that is supplementary image data expressing a reduced-size image of the main image are stored in a single file, the user always needs to select whether the main image or the supplementary image is to be printed. Since it is normally unlikely for the supplementary image to be the printing target, the user needs to perform an unnecessary selection operation. Also in the case of loading a single file containing multiple pieces of image data into a piece of application software, similarly to the problem in the case of printing, image data not intended by the user ends up being loaded into the application software.

### SUMMARY OF THE INVENTION

An aspect of the present invention is to eliminate the above-mentioned problems with the conventional technology.

The present invention provides an information processing apparatus and an information processing method in which, in the case of processing a file containing multiple pieces of image data, processing is performed on, among the multiple pieces of image data, an image data piece suited to the intended use with respect to instructed processing.

The present invention in its first aspect provides an information processing apparatus that processes a file containing a plurality of image data pieces and a header describing an intended use of the plurality of image data pieces comprising:

a storage unit configured to store the file;

a reception unit configured to receive an instruction to perform processing with use of an image data piece from among the plurality of image data pieces;

a determination unit configured to determine, based on the instructed processing and the intended use described in the header, an image data piece from among the plurality of image data pieces to be a target of the processing; and

a processing unit configured to process the image data piece determined to be the target of the processing.

The present invention in its second aspect provides an information processing method executed in an information processing apparatus that processes a file containing a plurality of image data pieces and a header describing an intended use of the plurality of image data pieces comprising the steps of:

receiving an instruction to perform processing with use of an image data piece from among the plurality of image data pieces;

determining, based on the instructed processing and the intended use described in the header, an image data piece from among the plurality of image data pieces to be a target of the processing; and

processing the image data piece determined to be the target of the processing.

According to the present invention, in the case of processing a file containing multiple pieces of image data, processing can be performed on, among the multiple pieces of image data, an image data piece suited to the intended use with respect to instructed processing.

Further features of the present invention will become apparent from the following description of exemplary embodiments with reference to the attached drawings.

### BRIEF DESCRIPTION OF THE DRAWINGS

FIG. 1 is a diagram showing an outline of a configuration of an information processing apparatus.

FIG. 2 is a diagram showing an outline of a procedure for processing a file containing multiple pieces of image data.

FIG. 3 is a diagram showing an outline of a configuration of a file containing multiple pieces of image data.

FIG. 4 is a diagram showing a first concrete example of the configuration of the file shown in FIG. 3.

FIG. 5 is a diagram showing a second concrete example of the configuration of the file shown in FIG. 3.

FIG. 6 is a diagram showing a third concrete example of the configuration of the file shown in FIG. 3.

FIG. 7 is a diagram showing a fourth concrete example of the configuration of the file shown in FIG. 3.

FIG. 8 is a diagram showing an outline of a procedure for processing a file containing multiple pieces of image data.

FIG. 9 is a diagram showing an example of a screen for making an image selection.

FIG. 10 is a diagram showing an example of a screen for setting image data extraction methods.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals have been given to constituent elements that are the same, and descriptions thereof will not be given.

### Embodiment 1

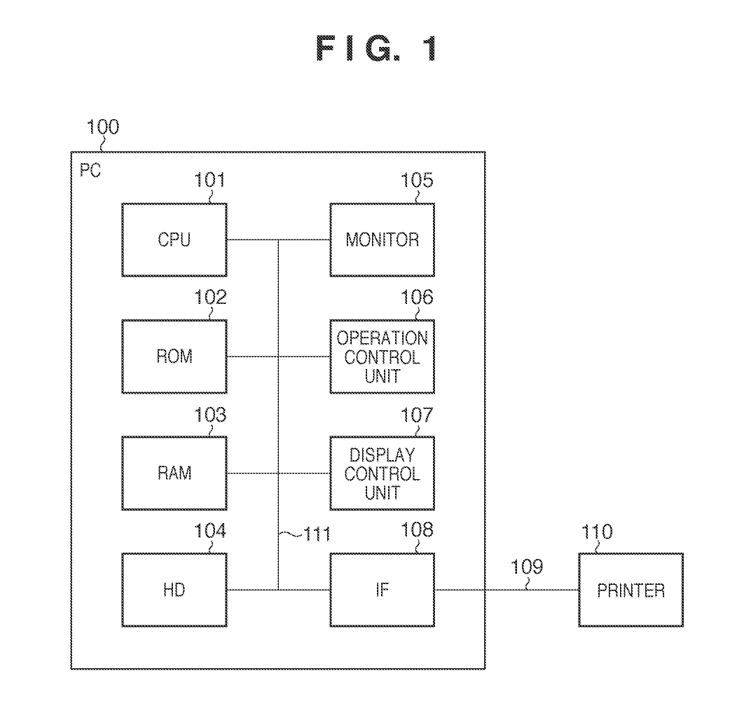

FIG. 1 is a block diagram showing a configuration of an image processing apparatus in the present embodiment. A PC 100 that is an information processing apparatus is connected to an external printer 110 via an interface cable 109 such that bidirectional communication is possible. The PC 100 includes a CPU 101 that controls constituent elements in the PC 100 based on programs in an OS or the like that is basic software, and a ROM 102 that records, for example, programs executed at the time of startup of the PC 100. The PC 100 also includes a RAM 103 that is used as a buffer area for a work area necessary in the execution of programs, and an HD (hard disk) 104 that stores the OS, application software, and various types of data. The PC 100 furthermore includes a monitor 105 that visually displays various types of information, and an operation control unit 106 that detects input operations performed by a user via an input device such as a keyboard or a mouse, and that performs control according to the input operations. The PC 100 still further includes a display control unit 107 that controls the display of various types of information on the monitor 105, and an interface 108 for performing the transmission and reception of various types of data with external devices, including image forming apparatuses such as printers and MFPs. These constituent elements are connected to each other via a bus 111 such that data can be transmitted and received. Also, although not particularly shown, the PC 100 also includes, for example, an optical disc drive capable of reading and writing data from/to a CD or DVD, and an input device such as a keyboard or a mouse.

In the PC 100, various types of files such as document files and image files are stored in predetermined directories (hereinafter, referred to as “folders”) that are prescribed in the hard disk 104. Also, file icons corresponding to the files or folder icons corresponding to the folders storing the files are displayed by the monitor 105 along with their names. Using the input device such as the keyboard or the mouse, such file icons or folder icons can be selected by the user with a single click, opened with a double click, and stored in another folder with a drag-and-drop operation. Note that configurations pertaining to this are generally widely-known.

Also, in the PC 100, various types of functions are provided by the OS, such as the display of user interface (UI) screens displayed by the monitor 105, and the storage of document files. Furthermore, the OS has device drivers in the form of software that can control predetermined hardware independently of the kernel, which is the core portion of the OS. As one example of these device drivers, a printer driver program (also referred to as a “printer driver”) is installed that can recognize a printer that is the output destination of a file on the PC 100 side, set various types of print conditions, and perform printer control. The printer driver is generally installed in the PC 100 from an external recording medium such as an optical disk (e.g., a CD-ROM or DVD-ROM) that is packaged with the printer itself at the time of sale. In the PC 100, based on the functionality of the printer driver, if an icon indicating a predetermined file in a UI screen displayed by the monitor 105 is dragged and dropped onto an icon indicating the printer 110, a print instruction is accordingly given to the printer 110. Such a print instruction function is generally widely-known.

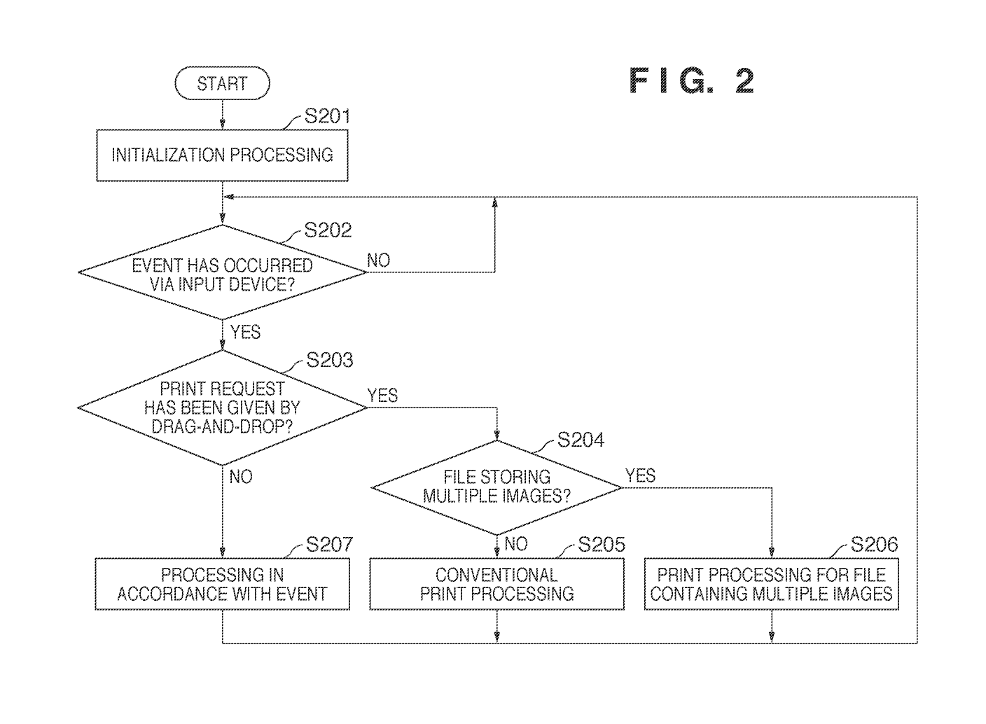

The following is a detailed description of processing executed by the PC 100 in relation to the print instruction function described above. FIG. 2 is a flowchart showing an overall procedure of processing that is started in the PC 100 according to the switching on of a power supply. The processing shown in FIG. 2 is executed by the CPU 101, for example. In this processing, first, general initialization processing is performed in which, for example, the memory such as the RAM 103 is cleared and the operating system is started up (S201). Thereafter, a determination is made as to whether an event has occurred due to receiving a user instruction via the input device such as the keyboard or the mouse (S202), and S202 is repeated again if the result of the determination is that an event has not occurred. On the other hand, if the result of the determination is that an event has occurred, a determination is made as to whether a print request has been given by dragging and dropping a file onto the printer icon in the user interface screen displayed by the monitor 105 of the PC 100 (S203).

If the result of S203 is that a print request has been given by a drag-and-drop operation, the procedure proceeds to S204. In S204, the extension and file format of the dragged and dropped file is analyzed, and a determination is made as to whether the file is a file storing multiple images. The determination as to whether the file is a file storing multiple images can be easily made by, for example, determining whether the file includes an identification code consisting of several bytes beginning at the head of the file.

If the file is determined to not be a file storing multiple images in S204, the procedure proceeds to conventional print processing due to a drag-and-drop operation (S205). In S205, print data in accordance with the given file is created and sent to the printer 110 via the IF 108. Upon receiving the print data from the PC 100, the printer 110 prints the print data onto a printing medium. The processing in S205 is generally known print processing. After the processing in S205 ends, the procedure returns to S202, and the occurrence of an event is again waited for.

On the other hand, if the file is determined to be a file storing multiple images in S204, the procedure proceeds to print processing for a file containing multiple images in S206. The details of S206 will be described later. In S206, an image data piece that is to be actually printed is selected from among the image data pieces contained in the file storing multiple images, either automatically or by a further user selection. Print data in accordance with the extracted image data piece is created, sent to the printer 110 via the IF 108, and then printed. After S206 ends, the procedure returns to S202, and the occurrence of an event is again waited for. Also, if the result of S203 is that a print request has not been given by a drag-and-drop operation, processing in accordance with the event that occurred is performed (S207), and after such processing ends, the procedure returns to S202, and the occurrence of an event is again waited for.

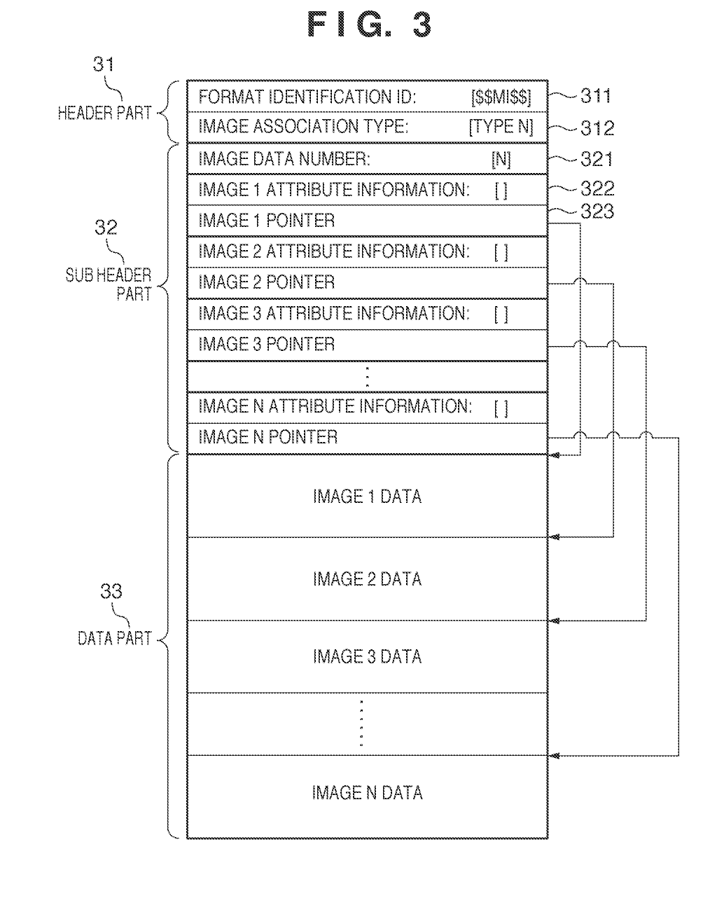

Next is a description of the file format of the file storing multiple images. FIG. 3 is a diagram showing an overall file configuration. The file storing multiple images is divided into three main categories, namely a header part 31, a sub header part 32, and a data part 33. The header part 31 is configured by a format identification ID 311 for identifying the file format, and an image association type 312. The format identification ID 311 is embedded as an ASCII code at the head of the file. For example, if the format identification ID for the format described here is the six-byte character string “$$MI$$”, when file analysis is performed, a determination is made as to whether the first six bytes of the file are “$$MI$$”, thus easily distinguishing whether the file format is the format described here. The image association type 312 indicates a type indicating associations between images. For example, type 1 is indicated if the file storing multiple images stores image data pieces that are in a main image-supplementary image relationship, and type 2 is indicated if the file storing multiple images is a single file that is a collection of individual image data pieces captured from multiple shooting points. In other words, in the present embodiment, the “type” described in the header can be said to express the intended use of the image data pieces stored in the file storing multiple images, that is to say, how such image data pieces are to be used with respect to user-desired processing.

The sub header part 32 is configured by an image data number 321 indicating the number of image data pieces contained in the file, image attribute information 322 that stores various types of attribute information of the image data pieces, and image data pointers 323 that store head addresses of the image data pieces. The number of pieces of image attribute information 322 and image data pointers 323 corresponds to the number of image data pieces stored in the file. The content stored in the image attribute information 322 differs depending on the type indicated by the image association type 312. The content that is actually stored will be described later.

The data part 33 stores the image data pieces, the number of which corresponds to the image data number. There are no particular limits on the format of the image data itself. A general image format such as the Exif format, or a unique image format may be used, as long as the format enables the data to be handled by the system as image data and enables the creation of print data.

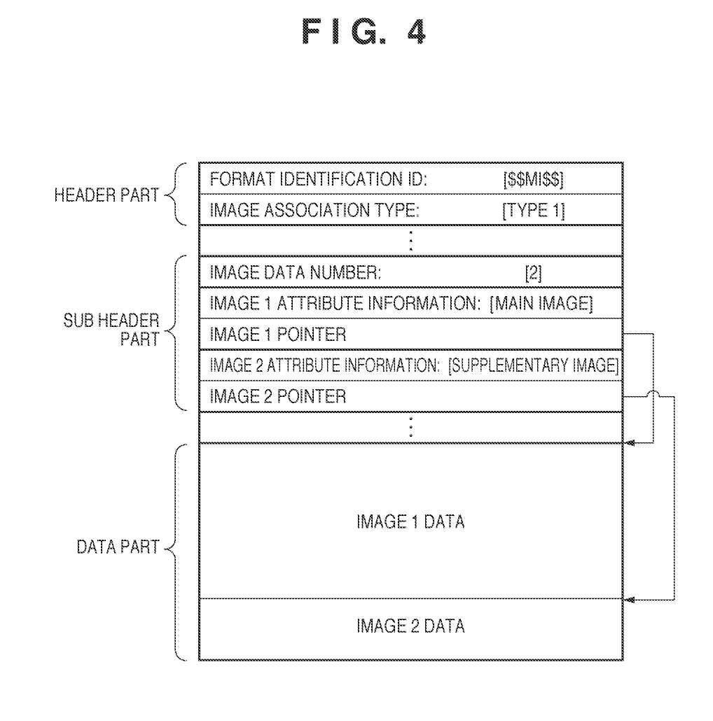

The following describes specific configurations depending on the image association types of the file storing multiple images. FIG. 4 is a diagram showing the configuration of the file storing multiple images in the case of the image association type 1. The file that is the image association type 1 is configured including two types of image data, namely image data of the main image and image data of the supplementary image that is a reduced-size image of the main image. The supplementary image is used in the case of performing a display in which a resolution as high as that of the main image is not necessary, such as a thumbnail display. Storing the supplementary image in the file in advance enables omitting size-reduction processing on the display side. Also, providing supplementary images that are different sizes enables utilizing a supplementary image in conformity with the size of the display region. The format identification ID and the image association type “type 1” are stored in the header part of the file storing multiple images in the case of the image association type 1. The image data number is stored in the sub header part, along with identifiers for identifying whether each image data piece is the main image or a supplementary image, as the image attribute information. In FIG. 4, image data 1 is the main image, and image data 2 is the supplementary image. The data part stores the image data pieces that are associated in the main image-supplementary image relationship in the sub header part.

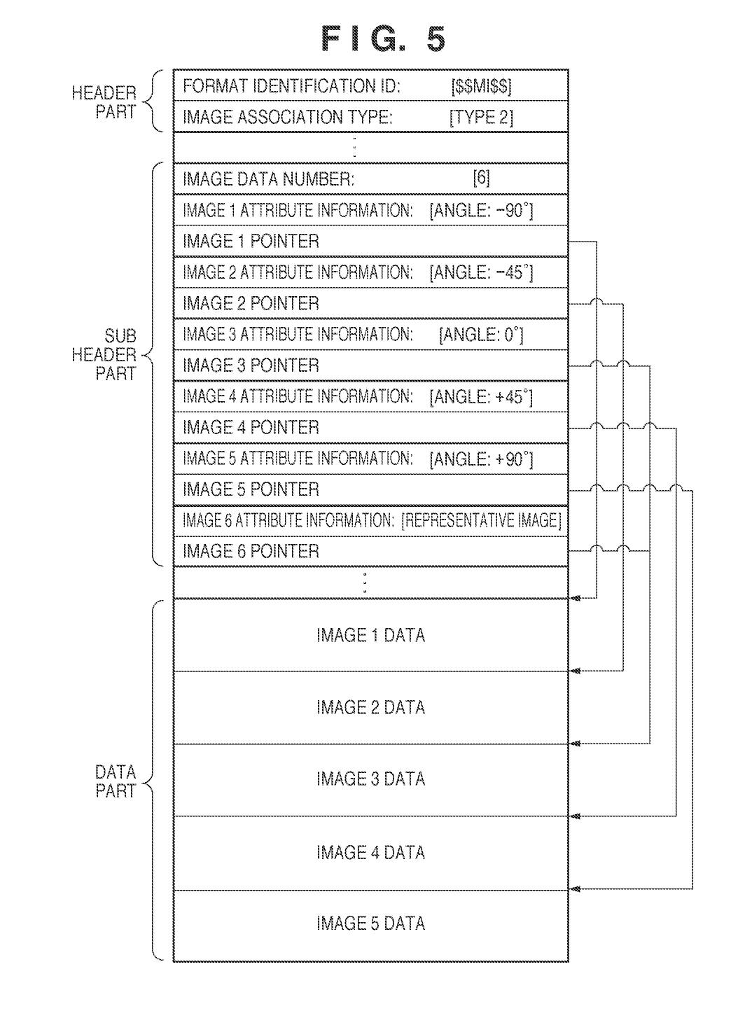

FIG. 5 is a diagram showing the configuration of the file storing multiple images in the case of the image association type 2. The image association type 2 is a type in which individual image data pieces captured from multiple shooting points are collected in a single file along with information indicating the shooting viewpoints. The format identification ID and the image association type “type 2” are stored in the header part in the case of the image association type 2. The image data number is stored in the sub header part, along with angle information indicating from which angle the image was captured for each image data piece, and pointers to target image data pieces, as the image attribute information. Also, depending on the image, an identifier indicating that the image is a representative image is stored as the image attribute information. In FIG. 5, the representative image is image 6, and the pointer for the actual image data points to the same data as image data 3. This indicates that the representative image 6 is actually the image data 3 whose viewpoint angle is 0 degrees. Also, the data part stores the image data pieces that are associated as images captured from various viewpoints in the sub header part.

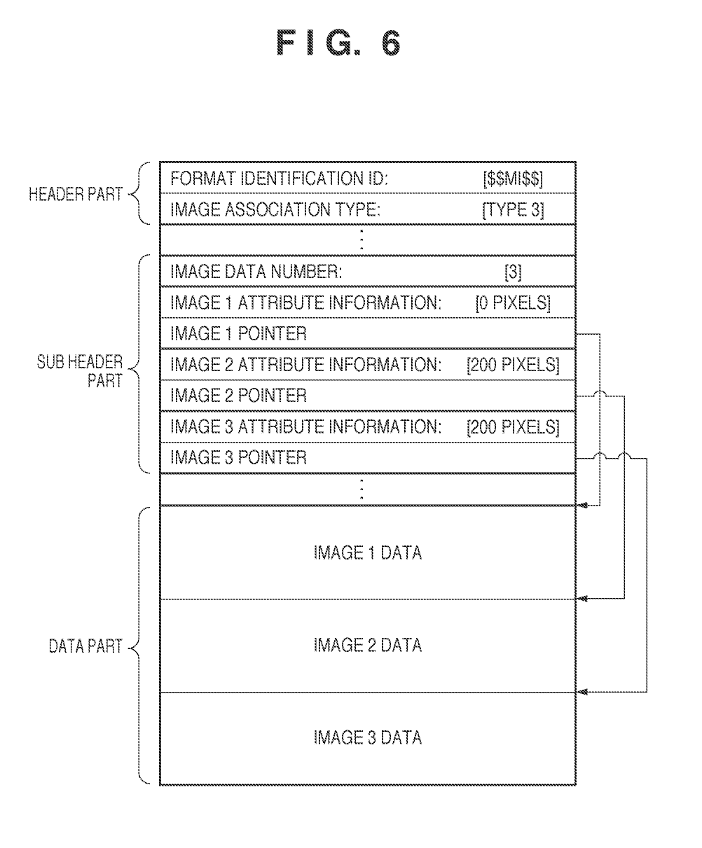

FIG. 6 is a diagram showing the configuration of the file storing multiple images in the case of the image association type 3. The image association type 3 is a type in which multiple images captured such that the image data pieces successively overlap each other slightly for the purpose of panorama image generation are collected in a single file. Note that in the present example, the image data pieces were captured while shifting the camera from left to right in the horizontal direction such that a portion of the scene overlaps with the previous image, and are indicated as image data 1, image data 2, and image data 3, which are in the capturing order. The format identification ID and the image association type “type 3” are stored in the header part in the case of the image association type 3. The image data number is stored in the sub header part, along with the number of pixels in a region of overlap with the image data piece that is adjacent on the left side, as the image attribute information. FIG. 6 shows that an image 1 and an image 2, as well as the image 2 and an image 3 were captured with 200 pixels of overlap therebetween. Utilizing the number of pixels that are overlapping between images enables easily generating a single panorama image by compositing multiple images. Also, the data part stores the image data pieces that are associated as portions of the panorama image in the sub header part.

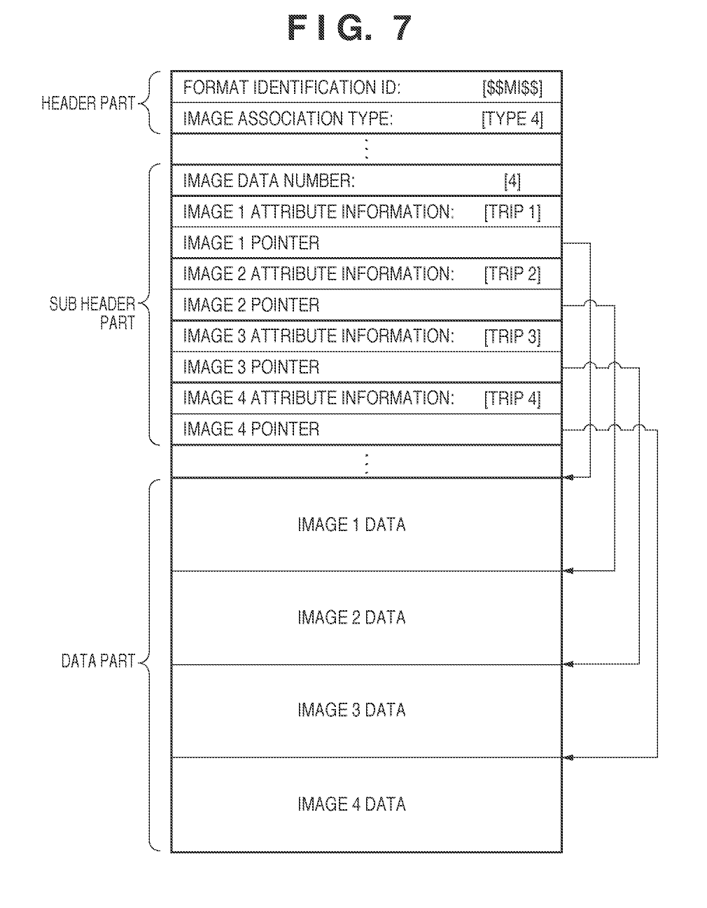

FIG. 7 is a diagram showing the configuration of the file storing multiple images in the case of the image association type 4. The image association type 4 is a type in which multiple images are simply collected in a single file. This is a file in which image data pieces selected arbitrarily by the user are collected in a single file, such as collecting image data pieces captured on trips in a single image file, or collecting image data pieces of the same person in a single image file. The format identification ID and the image association type “type 4” are stored in the header part in the case of the image association type 4. The image data number is stored in the sub header part, along with image names as the image attribute information. FIG. 7 shows an example in which four image data pieces from trips are stored. Also, the data part stores the image data pieces that have been arbitrarily selected by the user and are associated as images in mutually independent relationships in the sub header part.

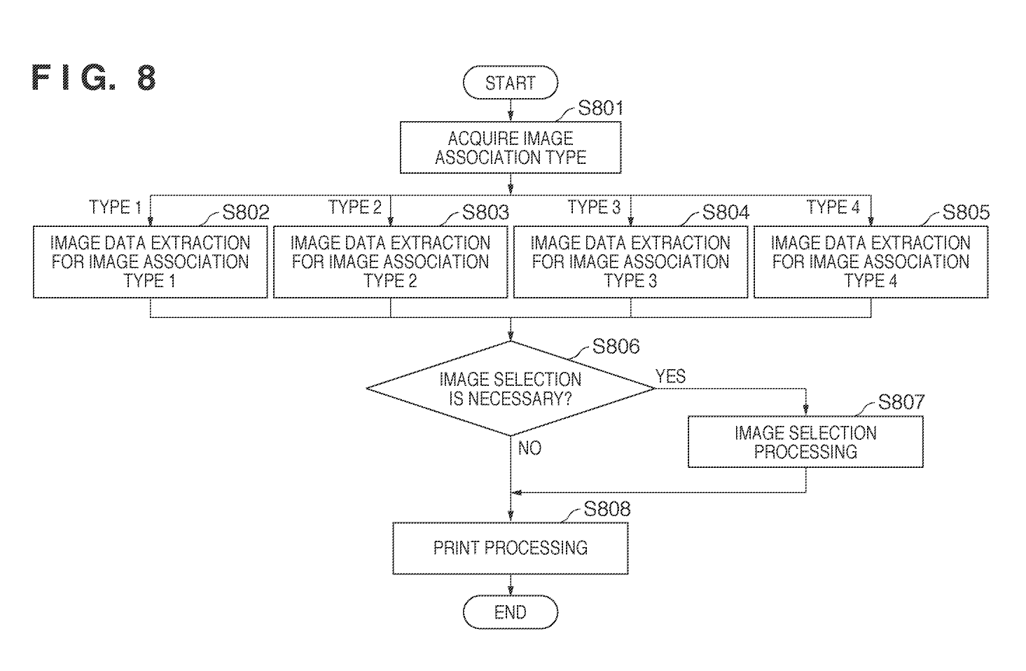

Next is a description of the details of the processing in S206 from when a file storing multiple images is dragged and dropped onto the printer icon on the desktop through when the file is printed by the printer 110, with reference to the flowchart in FIG. 8.

First, if the target file is determined to be a file storing multiple images in S204 in FIG. 2 as described above, the processing in S801 in FIG. 8 is started. In S801, the image association type stored in the header part at the head of the target file is acquired. Then, depending on the types 1 to 4, image data extraction processing corresponding to the type (S802, S803, S804, or S805) is performed.

S802 is image data extraction processing that is performed if the target file is the image association type 1. The attribute information in the sub header part of the target file is referenced, and only the image data piece that is the main image is extracted as extracted image data. The extracted image data is stored in an extracted image data storage buffer in the HD 104 of the PC 100, and thereafter the procedure proceeds to S806.

S803 is image data extraction processing that is performed if the target file is the image association type 2. The attribute information in the sub header part of the target file is referenced, and only the image data piece that is the representative image is extracted as extracted image data. The extracted image data is stored in the extracted image data storage buffer in the HD 104 of the PC 100, and thereafter the procedure proceeds to S806.

S804 is image data extraction processing that is performed if the target file is the image association type 3. The attribute information in the sub header part of the target file is referenced, a single panorama image is generated by compositing all the image data pieces, the composited panorama image data is set as the extracted image data, the extracted image data is stored in the extracted image data storage buffer in the HD 104 of the PC 100, and thereafter the procedure proceeds to S806.

S805 is image data extraction processing that is performed if the target file is the image association type 4. The attribute information in the sub header part of the target file is referenced, and the image data of all images is extracted as extracted image data. The extracted image data is stored in the extracted image data storage buffer in the HD 104 of the PC 100, and thereafter the procedure proceeds to S806.

In S806, the extracted image data storage buffer is checked, and the number of extracted image data pieces stored therein is acquired. If the number of stored extracted image data pieces is only 1, a determination is made that selection of an image by the user is not necessary, and the procedure proceeds to S808. In S808, print data is created from the extracted image data stored in the extracted image data storage buffer, the created print data is transmitted to the printer 110, and printing is executed. On the other hand, if the result of the determination in S806 is that the number of extracted image data pieces is 2 or more, a determination is made that the user needs to select image data that is to be printed, and the procedure proceeds to S807. In S807, first, thumbnail images of the extracted image data pieces stored in the extracted image data storage buffer are generated and displayed on the monitor 105, and the user is caused to select the image data that is to actually be printed.

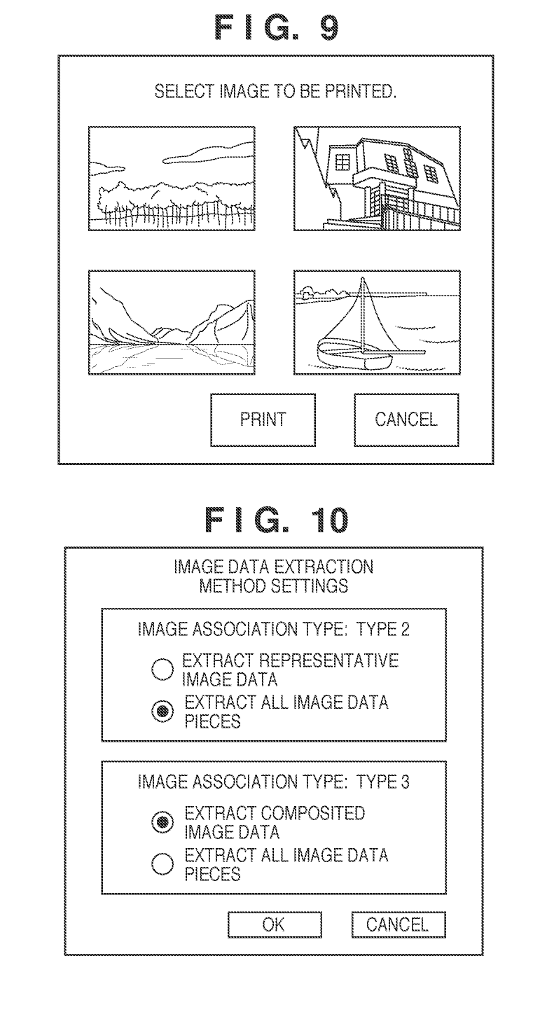

FIG. 9 shows an image selection screen displayed in S807. With use of an input device such as the mouse, the user selects an image data piece that is to actually be printed from among displayed thumbnail images, and presses a print button. Among the extracted image data pieces stored in the extracted image data storage buffer, the extracted image data pieces other than that selected by the user are deleted when the print button is pressed by the user. Accordingly, ultimately only the image data piece selected by the user is stored in the extracted image data storage buffer. Then, after the update processing has been performed on the extracted image data storage buffer, the print processing in S808 described above is performed. Similarly to as described above, at this time print data is created from the image data stored in the extracted image data storage buffer, the created print data is transmitted to the printer 110, and printing is executed. If the user has selected multiple pieces of image data in S807, multiple images are printed. Thus, print processing with respect to the file storing multiple images ends. Thereafter, the procedure proceeds to S202 shown in FIG. 2, and the occurrence of an event is again waited for.

Next is a description of the flow of processing in the case of printing by dragging and dropping the files storing multiple images shown in FIGS. 4 to 7, in accordance with the processing flow in FIG. 8. When printing is to be performed by dragging and dropping the file storing multiple images shown in FIG. 4, first “type 1” is acquired as the image association type in S801, and in S802 only the image data of image data 1, which is the main image, is extracted. In S806, “1” is acquired as the number of image data pieces extracted in S802, and therefore the procedure proceeds to the print processing in S808, and the image data 1 is printed without any further processing. When printing is to be performed by dragging and dropping the file storing multiple images shown in FIG. 5, first “type 2” is acquired as the image association type in S801, and in S803 only the image data of image data 3, which is the representative image, is extracted. In S806, “1” is acquired as the number of image data pieces extracted in S803, and therefore the procedure proceeds to the print processing in S808, and the image data 3 is printed without any further processing.

When printing is to be performed by dragging and dropping the file storing multiple images shown in FIG. 6, first “type 3” is acquired as the image association type in S801. In S804, panorama image data is generated by compositing three image data pieces, namely image data 1 to 3, and the composited image data piece is set as the extracted image data. In S806, “1” is acquired as the number of image data pieces extracted in S804, and therefore the procedure proceeds to the print processing in S808, and the composited panorama image data is printed without any further processing. When printing is to be performed by dragging and dropping the file storing multiple images shown in FIG. 7, first “type 4” is acquired as the image association type in S801. In S805, four image data pieces, namely image data 1 to 4, are extracted, and in S806, since “4” is acquired as the number of image data pieces extracted in S805, the procedure proceeds to the image selection processing in S807. In S807, thumbnail images of the four image data pieces (i.e., image data 1 to 4), are displayed, and the user is caused to make an image selection. The user then selects, for example, image 2 and image 4 and presses the print button, and thereafter the procedure proceeds to the print processing in S808, and the image data of the user-selected image 2 and image 4 is printed.

As described above, when a file has a format that enables the storage of multiple pieces of image data in a single file, and furthermore enables identification of the association between the stored image data pieces, and such file is to be printed without the intervention of application software, the selection screen is displayed only when the user needs to make an image selection. As a result, it is possible to reduce unnecessary user selection operations and improve usability when performing printing.

Also, the image data extraction methods shown in S802 to S805 that are performed depending on the image association type are not limited to the methods described above. For example, a configuration is possible in which in the case of the image association type 2, all the image data pieces contained in the file are set as extracted image data pieces, and the user is caused to make an image selection in S807. Furthermore, a configuration is possible in which in the case where a representative image exists, the representative image data is set as the extracted image data, and in the case where a representative image does not exist, all the pieces of the image data are set as the extracted image data pieces. Also, a configuration is possible in which the viewpoint angle information of the images is used to set an image data piece that is closest to a central angle from among all the images contained in the file, as the extracted image data piece. Also, a configuration is possible in which in the case of the image association type 3, compositing is not performed, and simply all the image data pieces are set as the extracted image data pieces.

Also, as described above, since various image data extraction methods are conceivable depending on the image association type, a configuration is possible in which the user is caused to set in advance the image data extraction methods for the image association types. The user starts up an image data extraction method setting program that exists in the HD 104 of the PC 100, and sets the image data extraction methods for the image association types, and the image data extraction method setting program writes the setting values that have been set to a setting file provided in advance. Then, in the image data extraction processing in S802 to S805 in FIG. 8, image data extraction methods are performed in accordance with the setting values in the setting file. Enabling the image data extraction methods to be changed with use of the setting file in this way makes it possible to extract image data that is closer to the user's intention. FIG. 10 is a diagram showing an example of a setting screen. Image data extraction methods can be selected in the cases of image association types 2 and 3, the extraction of all image data pieces is set in the case of type 2, and the extraction of a composited image data piece is set in the case of type 3.

Also, in printing by a drag-and-drop operation, a forced printing mode may be provided in which, if a file is dragged and dropped onto the print icon while a specified key is being pressed, all the image data pieces contained in the file are always extracted and printed, regardless of the image association type. This mode is effective in the case of printing a file that is the image association type 4, in the case in which the user desires to print all the image data pieces in a file, and the like. In such cases, printing in the forced printing mode eliminates the need for the user to perform the unnecessary task of making an image selection.

The forced printing mode can be realized by making the following changes to the processing flow in FIG. 8. In the image data extraction processing in S802 to S805, a detection is made as to whether the current mode is the forced printing mode due to a specific key that instructs forced printing having been pressed when the printing instruction was given. In the case of the forced printing mode, all the image data pieces in the file storing multiple images are forcibly set as extracted image data pieces, and in the case where the current mode is not the forced printing mode, image data pieces are extracted in accordance with the normal image data extraction method. Then, in the case of the forced printing mode, the procedure proceeds to S808 without performing the determination regarding the number of extracted image data pieces in S806, and all the image data pieces are printed. Naturally, in the case where the present mode is not the forced printing mode, the normal determination processing is performed in S806. Thus, processing in the case of the forced printing mode ends.

Also, with Linux for example, various types of image files can be printed by giving a print command and a filename from the command line. The present embodiment is also applicable to printing performed from the command line in this way. Specifically, in the case of analyzing a given file and creating printing data, conventional processing is performed if the file has a conventional file format, and printing data creation and printing are performed in accordance with the processing flow in FIG. 8 if the file is a file storing multiple images. Accordingly, the present embodiment is applicable to printing from the command line as well. Also, by designating the forced printing mode using a command line option, the forced printing mode can also be realized using a method similar to that in the above-described case of performing printing by a drag-and-drop operation.

Also, although an example in which four image association types exist is given in the present embodiment, there is no limitation to the above-described associations between images in the case in which multiple pieces of image data are collected in a single file, nor to the above-described image data extraction methods. Alternatively, a configuration is possible in which consecutively captured image data pieces are collected in a single file, and all the image data pieces are extracted at the time of image data extraction. Also, a configuration is possible in which multiple pieces of image data captured at different exposures are collected in a single file, and all the image data pieces are extracted at the time of image data extraction. Furthermore, a configuration is possible in which an original image and image data obtained by performing correction such as backlight correction are collected in a single file, and only the corrected image data is extracted at the time of image data extraction. Moreover, a configuration is possible in which RAW data of a digital camera and JPEG-format image data generated from the RAW data are collected in a single file, and the JPEG-format image data is extracted at the time of image data extraction.

In the present embodiment, the format of the file storing multiple images has been described with use of FIG. 3. However, the present embodiment is applicable as long as the target file has a format that enables multiple image data pieces to be contained in a single file, and furthermore enables identification of the association between the stored image data pieces, and therefore the target file is not limited to the configuration shown in FIG. 3.

### Embodiment 2

When loading a file storing multiple images into a piece of application software, there are cases in which, similarly to the problem in the case of printing, image data not intended by the user ends up being loaded into the application software. For example, if the file storing multiple images that is the image association type 4 shown in FIG. 7 is simply loaded into the application software, the four image data pieces are loaded, and therefore image data other than the image data that the user actually desires to edit ends up being loaded as well. On the other hand, if the user is always caused to select the image to be loaded before image data is loaded into the application software, the user always needs to select an image even in the case where the file containing multiple images is the image association type 1 (FIG. 4), and therefore the user needs to perform an extra operation.

In view of this, in the present embodiment, a description is given in which the ease of use for the user can be improved similarly to as in Embodiment 1, even in the case of loading a file storing multiple images into a piece of application software. Note that in the present embodiment, image data is sent to an image-editing processing unit incorporated in a file-loading processing unit in the application software. Upon receiving the image data, the image-editing processing unit puts the images therein in an editable state.

The following describes a processing flow performed when the file loading processing unit in the application software receives the file storing multiple images, with reference to FIG. 8. First, the file storing multiple images is dragged and dropped into the application software, or the file storing multiple images is designated in a file loading menu in the application software. In S801, the file-loading processing unit analyzes the header part of the file, checks the image association type, and performs processing in conformity with the image association type of the target file in S802 to S805. As a result of the processing in S802 to S805, extracted image data is stored in the extracted image data storage buffer, and then the procedure proceeds to S806. Note that the image data extraction is performed similarly to as described in Embodiment 1. In S806, the extracted image data storage buffer is checked, and if only one piece of extracted image data is stored in the storage buffer, the image data piece in the extracted image data storage buffer is sent to the image-editing processing unit of the application software as the loaded image data. On the other hand, if the result of the checking performed in S806 is that “2” is the number of pieces of extracted image data in the extracted image data storage buffer, the procedure proceeds to S807.

In S807, first, thumbnail images of the extracted image data pieces stored in the extracted image data storage buffer are generated and displayed on the monitor 105, and the user is caused to select the image data that is to actually be loaded into the application software. With use of an input device such as the mouse, the user selects an image data piece that is to actually be loaded from among displayed thumbnail images, and presses a confirmation button. Among the extracted image data pieces in the extracted image data storage buffer, the extracted image data pieces other than that selected by the user are deleted when the confirmation button is pressed by the user. Accordingly, only the image data selected by the user is stored in the extracted image data storage buffer. Lastly, the image data in the extracted image data storage buffer is sent to the image-editing processing unit in the application software as loaded image data. Thus, the processing flow performed when loading a file into the application software ends.

In accordance with the aforementioned processing flow, if the file storing multiple images shown in FIG. 4 has been loaded, the image data 1 that is determined to be the main image in S802 is extracted as the extracted image data and stored in the extracted image data storage buffer. Thereafter, since “1” is acquired as the number of pieces of extracted image data in S806, the image data 1 is loaded into the application software. Also, if the file storing multiple images shown in FIG. 7 has been loaded, the four image data pieces are extracted as the extracted image data in S805, and then stored in the extracted image data storage buffer. Thereafter, since “4” is acquired as the number of pieces of extracted image data in S806, the procedure proceeds to S807. In S807, thumbnail images of the four image data pieces (i.e., image data 1 to 4) are displayed in the selection screen, and the user is caused to make an image selection. The user then selects, for example, image 2 and image 4 and presses the confirmation button, and thereafter the image data 2 and the image data 4 is loaded into the application software.

As described above, when a file has a format that enables the storage of multiple pieces of image data in a single file, and furthermore enables identification of the association between the stored image data pieces, and such a file is to be loaded into application software, the selection screen is displayed only when the user needs to make an image selection. As a result, it is possible to reduce unnecessary user selection operations and improve usability when loading a file into application software.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-142708, filed Jun. 15, 2009, which is hereby incorporated by reference herein in its entirety.

What is claimed is:

1. An information processing apparatus that processes a file containing a plurality of image data pieces and a header describing an intended use of the plurality of image data pieces, comprising:
a storage unit configured to store the file;
a reception unit configured to receive an instruction to perform processing with use of an image data piece from among the plurality of image data pieces;
a determination unit configured to determine, based on the instructed processing and the intended use described in the header, an image data piece from among the plurality of image data pieces to be a target of the processing; and
a processing unit configured to process the image data piece determined to be the target of the processing.

2. The information processing apparatus according to claim 1, wherein the information processing apparatus is a printing apparatus, and the processing is print processing.

3. The information processing apparatus according to claim 2, further comprising a display unit configured to, in a case in which a plurality of the image data pieces have been determined by the determination unit to be the target of the print processing, display a selection screen so as to enable a user to make a selection from among the plurality of image data pieces determined to be the target.

4. An information processing method executed in an information processing apparatus that processes a file containing a plurality of image data pieces and a header describing an intended use of the plurality of image data pieces, comprising the steps of:
receiving an instruction to perform processing with use of an image data piece from among the plurality of image data pieces;
determining, based on the instructed processing and the intended use described in the header, an image data piece from among the plurality of image data pieces to be a target of the processing; and
processing the image data piece determined to be the target of the processing.
